(19) United States
(12) Patent Application Publication
(10) Pub. No.: US 2022/0044243 A1
(43) Pub. Date: Feb. 10, 2022

(54) SMART ACCOUNT CONTROL FOR AUTHORIZED USERS

(71) Applicant: International Business Machines Corporation, Armonk, NY (US)

(72) Inventors: Randy A. Rendahl, Raleigh, NC (US); Ashley Kristin Silva, Durham, NC (US); JOCELYN SESE, Knightdale, NC (US); Frank Isaacs, Wake Forest, NC (US)

(21) Appl. No.: 16/987,904

(22) Filed: Aug. 7, 2020

(51) Int. Cl. G06Q 20/40; H04L 29/06; G06Q 30/00; G06Q 40/02; G06Q 10/10; G06Q 20/22

(52) U.S. Cl. CPC G06Q 20/405; H04L 63/20; G06Q 20/2295; G06Q 40/02; G06Q 10/10; G06Q 30/0185

(57) ABSTRACT

A computer-implemented system and method for controlling access to an account comprises, in a policy definition phase, receiving instructions to add an authorized user to an account from a primary user associated with the account. The method further comprises receiving, from the primary user, policy rules comprising one or more rules that restrict use of the account by the authorized user. In an account use phase, the method comprises receiving a transaction by the authorized user from a merchant, performing a policy rules determination that the transaction relates to a plurality of items and that one of the plurality of items does not meet the policy rules, and rejecting the transaction based on the policy rules determination.

### BACKGROUND

Disclosed herein is a system and related method for providing smart account control for authorized users.

The use of electronic accounts, such as credit cards along with their related accounts, has grown significantly in recent years. In order to increase the usefulness of credit card accounts, the account holder might add additional users, such as family members, who may make purchases against the credit card account. However, although these additional users may benefit from using the credit card, they are not the ones ultimately responsible for payment. Without the ability to exercise control over these additional users, problematic situations may develop, e.g., since the additional users are not ultimately responsible to the account provider for their transactions.

### SUMMARY

According to one aspect disclosed herein, a computer-implemented method for controlling access to an account is provided comprising, in a policy definition phase, receiving instructions to add an authorized user to an account from a primary user associated with the account. The method further comprises receiving, from the primary user, policy rules comprising one or more rules that restrict use of the account by the authorized user. In an account use phase, the method comprises receiving a transaction by the authorized user from a merchant, performing a policy rules determination that the transaction relates to a plurality of items and that one of the plurality of items does not meet the policy rules, and rejecting the transaction based on the policy rules determination.

According to another aspect disclosed herein, an account control system is provided, comprising a processor configured to, in a policy definition phase, receive instructions to add an authorized user to an account from a primary user associated with the account, and receive, from the primary user, policy rules comprising one or more rules that restrict use of the account by the authorized user. In an account use phase, the processor is configured to receive a transaction by the authorized user from a merchant, perform a policy rules determination that the transaction relates to a plurality of items and that one of the plurality of items does not meet the policy rules, and reject the transaction based on the policy rules determination.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a data processing system (DPS) according to some embodiments.

FIG. 4 is a block diagram of an account control system, according to some embodiments.

FIG. 5 is a flowchart of an overall process for operating the account control system, according to some embodiments.

### DETAILED DESCRIPTION

### Overview of Account Control System

A smart account control system and related method provide a primary account user (account owner) to, at a high level of granularity, control activities of those users who have been authorized by the primary account user to use the account (authorized users). This may be accomplished by providing a detailed set of activities (policies) that the authorized users (individually or collectively) may perform with respect to the account. This may include limitations on products or product types, time limitations, individual transaction amounts, cumulative amounts, etc. Furthermore, the policies may utilize complex rules that are easily changeable by the primary account user and may be picked up in real-time by the account provider. In some implementations, a point-of-sale transaction may comprise multiple items, but only one item may be prohibited by the policy. In this instance, it may be possible to alert the authorized user of the offending item, and they can remove it and successfully proceed with the transaction.

The following acronyms may be used below:
API application program interface
ARM advanced RISC machine
CD-ROM compact disc ROM
CMS content management system
CoD capacity on demand
CPU central processing unit
CUoD capacity upgrade on demand
DPS data processing system
DVD digital versatile disk
EPROM erasable programmable read-only memory
FPGA field-programmable gate arrays
HA high availability
IaaS infrastructure as a service
I/O input/output
IPL initial program load
ISP Internet service provider
ISA instruction-set-architecture
LAN local-area network
LPAR logical partition
PaaS platform as a service
PDA personal digital assistant
PLA programmable logic arrays
RAM random access memory
RISC reduced instruction set computer
ROM read-only memory
SaaS software as a service
SLA service level agreement
SRAM static random-access memory
WAN wide-area network

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

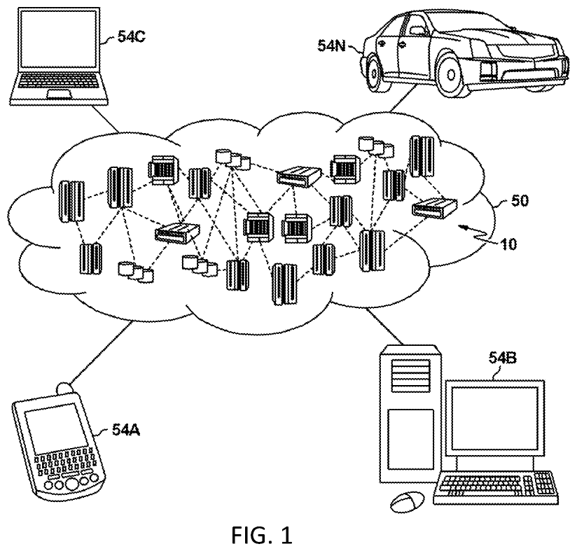

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

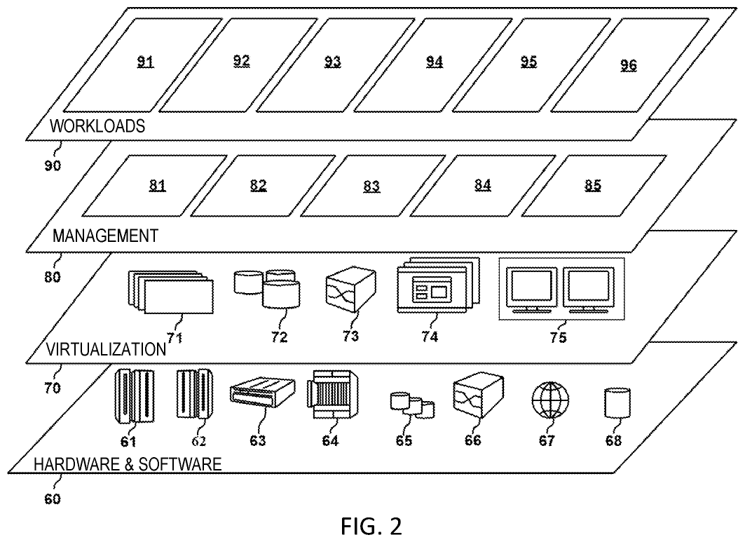

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

### Data Processing System in General

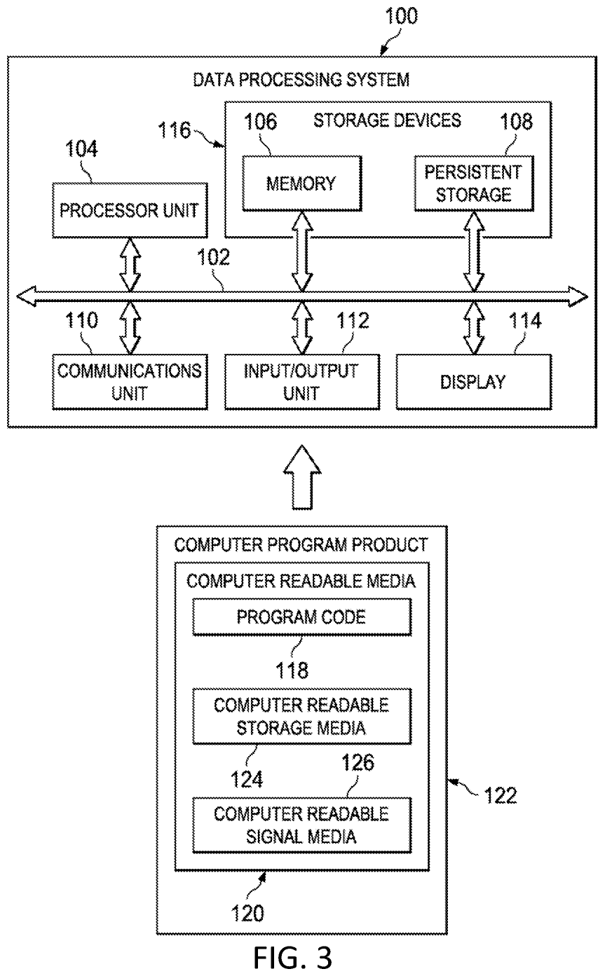

FIG. 3 is a block diagram of an example DPS according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an I/O unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100.

### Smart Account Control for Authorized Users

Financial institutions or other entities issue a variety of instruments that allow their customers to make electronic purchases at a point of sale, which may be physical or virtual. These instruments may include credit cards, debit cards, chip cards, smartphone devices, key fob devices, and other similar instruments. These may be used in various methods for paying a merchant and debiting the customer's account, which may be real-time from a checking account or adding to a ledger balance as in a line of credit, a credit card, or similar instrument. As defined herein, all of these instruments are “cards” or “credit cards”, without limitation to the specific list shown above. Also, as defined herein, a bank, credit union, lender, or similar financial institution constitute a “card issuer”, “card provider”, or “account provider”, without limitation to this list.

Most credit card accounts have an upper limit on credit that the account provider allows for the account holder. Although the ability to set spending limits on a credit card is known, there may be some benefit to permitting more complex rules to be put in place for a credit card, allowing the owner to more precisely control how the card is used. Disclosed herein is a system and method with credit card rules (policies) that enable spending limits to be applied on a small granular level with provisions for specifying spending categories, locations (e.g., locations of the user, locations of the merchant, etc.), times, vendors, etc. The system further permits the credit card rules to be viewed and changed real-time, and enables card issuers to accept or reject a transaction based on individual components of the transaction rather than the entirety of the transaction amount or location. By using an itemized list at the point of charging the card, the card issuer may accept or reject the transaction based on a user-defined rule set evaluation, and, in some embodiments, provide a message and/or code with details when a rejection occurs.

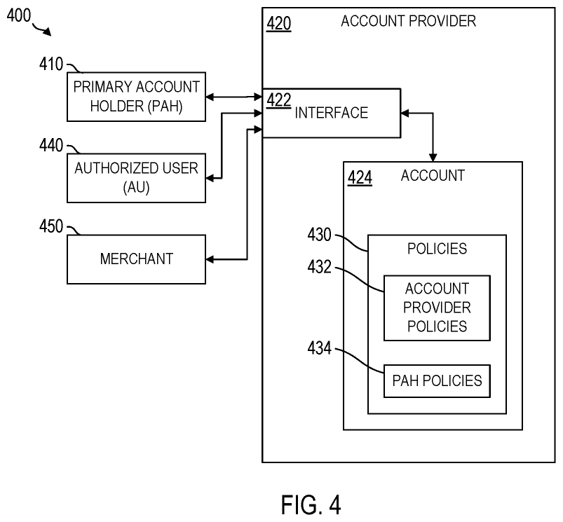

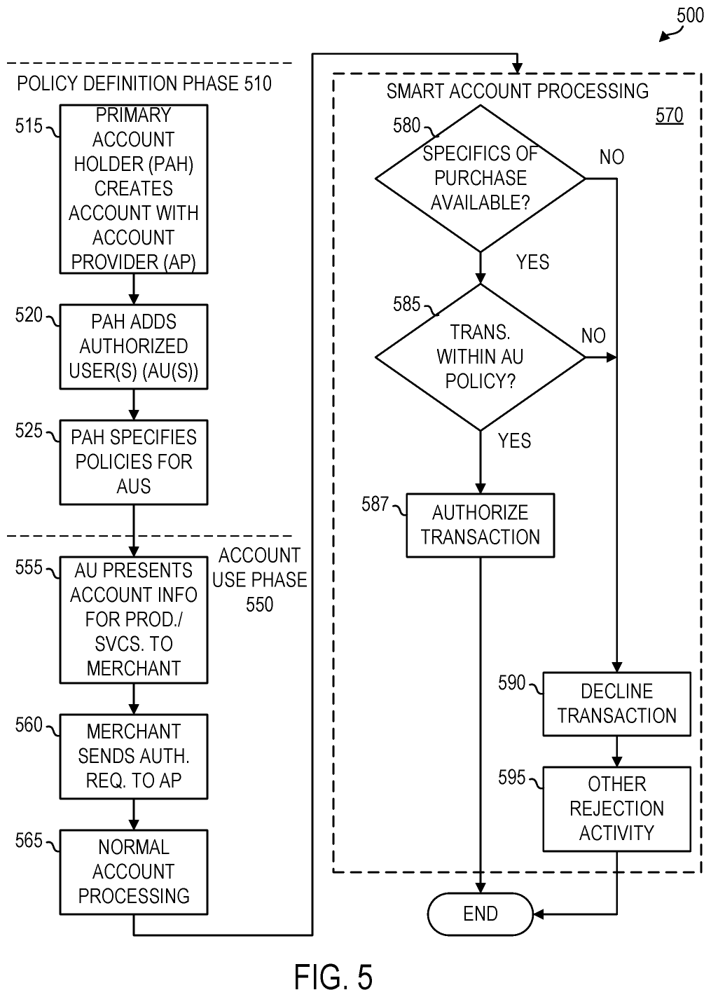

FIG. 4 is a block diagram of a system 400 for providing smart credit card control for authorized users, according to some implementations. The system 400 may comprise a processing system, such as the DPS 100, that may be configured to perform various operations and processes described herein. FIG. 5 is a flowchart of an overall process 500 for operating the system 400, according to some implementations. The overall process 500 may be divided into a policy definition phase 510, and an account use phase 550 that uses smart credit card processing 570. These are described in tandem in more detail below. The system and method may run in an environment such as the cloud computing environment 50.

### Policy Definition Phase

In the policy definition phase 510, in some embodiments, the primary account holder 410 (who may be referred to herein as the account owner) accesses the account provider's 420 services via an administrative interface 422 (e.g., a web site or an app). In operation 515, a person initially establishing an account, referred to herein as a primary account holder 410, establishes a credit card account with an account provider 420, which may typically be a bank or other financial institution. A primary account holder card 412 may be associated with a credit card account 424 and the primary account holder 410. Relevant account initialization information may be collected from the primary account holder 410 via, e.g., the administrative interface 422, and provided to the account provider 420, e.g., contact information, preferences, and the like. Similar relevant account initialization information may be provided to the primary account holder 410 from the account provider, e.g., account terms, credit limits, usage rules, and the like. This primary account holder card 412 may be used in accordance with certain policies 430. These policies 430 may comprise certain limitations on usage: account provider policies 432 that may be established by the account provider 420 (e.g., absolute maximum credit limits associated with a credit card account 424); and primary account holder policies 434 that may be established by the primary account holder 410 (e.g., notifications for various events).

In operation 520, the primary account holder 410 may further authorize others, referred to herein as authorized users 440, to access the account via an authorized user card 414. The use of the term “card” herein is not limited to a physical card, but may be a virtual card accessed and used solely electronically. The primary account holder 410 is the one who has the greatest control over the account 424. The primary account holder 410 may add the authorized users 440, using, e.g., the interface 422 to the account provider 420. The account holder 410 may, in some embodiments, define an authorized user 440, or a set of authorized users 440. These authorized users 440 are defined as users having access to the account 424, but potentially with some restrictions, due to policy 430 enforcement. The uniquely issued cards 412, 414 may have some form of identification on them that distinguishes them from other cards used with the account 424.

In operation 525, the account holder 410 may select an authorized user 440 to update any policies that might apply to them. In some embodiments, the account holder may then be presented, via the interface 422, with a utility that allows them to make changes to the primary account holder policies 434 regarding specific authorized users 440. The primary account holder policies 434 may include attributes, rules, criteria, etc. that limit, in some way, what the authorized user 440 may use the credit card for. In some embodiments, these policies may make use of an allowlist or a blocklist of attributes, such as products or product types, merchants, that may be used to limit use of the authorized user's card 414. The allowlist is a list of entities and/or attributes that must be met in order for the authorized user 440 to use the authorized user card 414. The blocklist is a list of entities and/or attributes that the authorized user card 414 cannot be used for. The primary account holder 410 may update the primary account holder policies 434, including, e.g., an allowlist or blocklist for the selected authorized user 440. In some embodiments, the primary account holder policies 434 may be updated at any time, and in some other embodiments, the policies 434 may be updated only at specific times. The authorized user policies 436 (profile) may be saved to the account provider's 420 system for use during purchase authorizations.

In addition to the use of an allowlist or blocklist for the selected authorized user 440, other primary account holder policies 434 may be implemented, including spending limits, location limits, caps on amount spent on particular products or product types, restricted retailer lists (allow or blocklist) that include specific merchants or merchant types, time oriented restrictions such as dollars per week or purchases per week for particular products or product types, etc.

Any of these attributes may be similar in form to an inclusive list (allowlist), and an exclusive list (blocklist), where it makes sense to do so. The policies 434 may further incorporate complex rules by using combinations of attributes joined with Boolean logic. For example, a policy 434 may be set up as (using stores only on List A) AND (transactions only made on weekends between 8:00a.m. and 5:00p.m.). Using such Boolean rules, the rules may be applied with a “deny, then permit” model or a “permit, then deny” model, for simplicity or fine control. For example, donut purchases may be denied in all cases except at a specific establishment on a Friday night, or cash withdrawals may be allowed at all locations except for between 10:00p.m. and 5:00a.m. In some embodiments, the primary account holder 410 may impose similar limitations on themself as are imposed on the authorized users 440. For example, the primary account holder 410 may add, as a primary account holder policy 434, a spending limit of $25 per week at the local donut shop.

Account Use Phase

In an account use phase 550, in some embodiments, the authorized user 440 makes a purchase with a merchant 450 who may be operating as a brick and mortar store merchant and/or as an online merchant. In operation 555, the authorized user 440 selects one or more products and/or services for purchase, and then presents their credit card 414 as payment to the merchant 450. In operation 560, the merchant 450 then submits an authorization request, to the account provider 420 (or an entity responsible for receiving and clearing the transaction information). The authorization request may include data that is used in a normal credit card transaction, including which authorized user card 414 is being used based, e.g., on an identifier associated with the card 414. In some implementations, an industry standard formatted data structure of a credit card transaction is transmitted as a part of the transaction, including itemized content of products and/or services being purchased with bar code or other standardized product identification.

Once the authorization request has been submitted to the account provider 420, the account provider may, in operation 565, perform normal credit card processing on the authorization request. The normal credit card processing may include, e.g., checking the credit limit, expiration date, proper signature, etc. (i.e., account provider policies 432) and the like. Although the FIG. 5 flowchart shows the normal credit card processing 565 occurring before any of the smart credit card processing 570, the invention is not so limited, and the normal credit card processing 565 may occur prior to, during, or after the smart credit card processing 570. In some embodiments, operations of the normal credit card processing 565 may be interleaved with operations of the smart credit card processing 570.

In some embodiments, the account provider 420 may determine that the authorized user card 414 utilizes the smart credit card control described herein by information associated with the account 424 itself. In some embodiments, such information may be in the form of a presence of primary account holder policies 434. In some embodiments, this determination may be made by, e.g., a flag in the information communicated to the account provider 420 in the authorization process.

In operation 580, a determination is made as to whether the merchant 450 provides specifics about the purchase, e.g., itemized content support. If the merchant 450 does not provide itemized content support (565:N), the account provider 420 may, in operation 590, decline the authorization request by sending an authorization failure. This prevents the authorized user 440 from bypassing a policy enforcement for the primary account holder policies 434. When the request is declined, in some embodiments, in operation 595, the account provider 420 may take some other activity related to declining the request, such as providing a reason for declining the transaction. In the presently described situation, the account provider may send text or a representative code indicating “Merchant does not provide detailed transaction information” or the like.

When the merchant provides itemized content support (580:Y), then in operation 585, the account provider 420 may determine if there are any primary account holder policies 434 that may be applicable to the authorized user 440. If so, a determination may be made as to whether the policies 434 preclude the purchase of any good or service that is a part of the transaction. If an allowlist is present in the policies 434, then each item in the transaction is tested to see if it is on the allowlist. A failure to find each and every transaction item on the allowlist results in a failure (585:N) and a declining of the transaction 590. If a blocklist is present in the policies 434, then any transaction item on the blocklist results in a failure (585:N) and a declining of the transaction in operation 590.

Furthermore, each and every rule and condition specified in the primary account holder policies 434 must be met (585:Y) before, in operation 587, the transaction is authorized, which may involve, among other things, sending an authorization response. Otherwise (585:N) the transaction is declined in operation 590. In operation 595, one of the other activities that may be performed is, as noted above, sending detailed information as to the cause of rejection. Such feedback may allow, in some implementations, for the authorized user 440 to adjust items purchased in the transaction in order to avoid not meeting the policy 434 restrictions. For example, if chewing gum is blocklisted, and the authorized user 440 has chewing gum as a part of their transaction along with other goods/services that are allowed, the other activity operation 595 may send back a message indicating that the chewing gum is not allowed. In some embodiments, it may ask the authorized user 440 or the merchant 450 if the chewing gum should be removed from the items in the transaction. If the response is affirmative, then the chewing gum is removed from the transaction, and the remainder of the transaction proceeds normally. An additional other activity in operation 595 may be to alert the primary account holder 410 and/or the authorized user 440 themselves. According to some embodiments, the system may permit the primary account holder 410 to view current and past spending details for an authorized user 440.

### Computer Readable Media

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for controlling access to an account, comprising using a processor for:
in a policy definition phase:
receiving instructions to add an authorized user to an account from a primary user associated with the account; and
receiving, from the primary user, policy rules comprising one or more rules that restrict use of the account by the authorized user; and
in an account use phase:
receiving a transaction by the authorized user from a merchant;
performing a policy rules determination that the transaction relates to a plurality of items and that one of the plurality of items does not meet the policy rules; and
rejecting the transaction based on the policy rules determination.

2. The method of claim 1, wherein the policy rules comprise a restriction based on a product criterion.

3. The method of claim 2, wherein the product criterion is selected from the group consisting of a product identification and a product type.

4. The method of claim 2, wherein the policy rules further comprise a restriction selected from the group consisting of a vendor location, an authorized user location, a time, a store, a merchant, and a merchant type.

5. The method of claim 1, wherein the account is selected from the group consisting of a credit card account, a debit card account, a savings account, a checking account, and a cash account.

6. The method of claim 1, wherein the rejecting of the transaction further comprises performing other rejection activity.

7. The method of claim 6, wherein the performing of the other rejection activity comprises providing feedback information related to the rejection.

8. The method of claim 7, further comprising:
performing a second policy rules determination that an other one of the plurality of items does meet the policy rules; and
based on the second policy rules determination:
the providing feedback information includes providing an indication of which of the plurality of items does not meet the policy rules.

9. The method of claim 8, further comprising:
receiving a second transaction by the authorized user from a merchant that does not include the item of the plurality of items that does not meet the policy rules; and
accepting the second transaction based on a second policy rules determination.

10. The method of claim 1, further comprising:
receiving, from the primary user, updated policy rules;
receiving a second transaction by the authorized user; and
applying the updated policy rules to the second transaction in real-time.

11. The method of claim 1, wherein the policy rules comprise an allowlist for an attribute indicating an attribute that must be found in all items of the transaction.

12. The method of claim 1, wherein the policy rules comprise a blocklist for an attribute indicating an attribute that cannot be found in any of the items of the transaction.

13. The method of claim 1, wherein prior to the performing of the policy rules determination, the method comprises:
performing normal credit card processing on the transaction; and
responsive to the transaction not passing the normal credit card processing, rejecting the transaction.

14. A control system for account access comprising a processor configured to:
in a policy definition phase:
receive instructions to add an authorized user to an account from a primary user associated with the account; and
receive, from the primary user, policy rules comprising one or more rules that restrict use of the account by the authorized user; and
in an account use phase:
receive a transaction by the authorized user from a merchant;
perform a policy rules determination that the transaction relates to a plurality of items and that one of the plurality of items does not meet the policy rules; and
reject the transaction based on the policy rules determination.

15. The system of claim 14, wherein:
the policy rules comprise a restriction based on a product criterion;
the product criterion is selected from the group consisting of a product identification and a product type; and
the policy rules further comprise a restriction selected from the group consisting of a vendor location, an authorized user location, a time, a store, a merchant, and a merchant type.

16. The system of claim 14, wherein:
the rejecting of the transaction further comprises performing other rejection activity; and
the performing of the other rejection activity comprises providing feedback information related to the rejection.

17. The system of claim 16, wherein the processor is further configured to:
perform a second policy rules determination that an other one of the plurality of items does meet the policy rules; and
based on the second policy rules determination:
the provide of the feedback information includes provide an indication of which of the plurality of items does not meet the policy rules.

18. The system of claim 17, wherein the processor is further configured to:
receive a second transaction by the authorized user from a merchant that does not include the item of the plurality of items that does not meet the policy rules; and
accept the second transaction based on a second policy rules determination.

19. A computer program product for a control system for account access, the computer program product comprising a computer readable storage medium having computer-readable program code embodied therewith to, when executed on a processor, cause the processor to:
in a policy definition phase:
receive instructions to add an authorized user to an account from a primary user associated with the account; and
receive, from the primary user, policy rules comprising one or more rules that restrict use of the account by the authorized user; and
in an account use phase:
receive a transaction by the authorized user from a merchant;
perform a policy rules determination that the transaction relates to a plurality of items and that one of the plurality of items does not meet the policy rules; and
reject the transaction based on the policy rules determination.

20. The computer program product of claim 19, wherein the computer readable product code further causes the processor to:
